(19) United States
(12) Patent Application Publication
(10) Pub. No.: US 2026/0367378 A1
(43) Pub. Date: Nov. 19, 2026

(54) SELECTIVE-PLANE ILLUMINATION MICROSCOPY WITH HIGH ÉTENDUE AND LONG WORKING DISTANCE OBJECTIVE LENSES

(71) Applicant: Allen Institute, Seattle, WA (US)

(72) Inventors: Adam Glaser, Seattle, WA (US); Jayaram Chandrashekar, Seattle, WA (US); Karel Svoboda, Seattle, WA (US)

(73) Assignee: Allen Institute, Seattle, WA (US)

(21) Appl. No.: 19/136,349

(22) PCT Filed: Dec. 11, 2023
(86) PCT No.: PCT/US2023/083330

§ 371 Date: Jun. 6, 2025

Related U.S. Application Data
(60) Provisional application No. 63/387,010, filed on Dec. 12, 2022.

(51) Int. Cl. G02B 21/00; G02B 21/33; G02B 21/36; G02B 27/00

(52) U.S. Cl. CPC G02B 21/0076; G02B 21/33; G02B 21/361; G02B 27/0025

(57) ABSTRACT

An expansion-assisted selective plane illumination microscope (ExA-SPIM) has diffraction-limited and aberration-free performance over a large field of view (e.g., 85 mm²) and working distance (e.g., 35 mm). ExA-SPIM enables molecular imaging across three-dimensional samples with high imaging throughput for applications in biology and neuroscience. Combined with new tissue clearing and expansion methods, ExA-SPIM allows nanoscale imaging of centimeter-scale samples, including entire mouse brains, with diffraction-limited resolutions and high contrast without sectioning. ExA-SPIM can be used to reconstruct individual neurons across the mouse brain, image cortico-spinal neurons in the macaque motor cortex, and trace axons in human white matter.

### CROSS-REFERENCE TO RELATED APPLICATIONS

This application claims the priority benefit, under 35 U.S.C. § 119(e), of U.S. Application No. 63/387,010, filed Dec. 12, 2022, which is incorporated herein by reference in its entirety for all purposes.

### GOVERNMENT SUPPORT

This invention was made with government support under CA240681 awarded by the National Institutes of Health. The government has certain rights in the invention.

### BACKGROUND

Biological tissue is organized over scales of nanometers to centimeters. Understanding individual cells and multicellular organization involves probing the architecture of tissue over these spatial scales simultaneously. However, standard microscope objectives have limited working distances (e.g., <1 mm) and fields of view (e.g., <1 mm). With standard microscope objectives, imaging large tissue volumes at high resolutions involves physical sectioning and tiling. Physical sectioning distorts the imaged tissue, and focal planes have optical distortions at the edges of the field of view. These factors complicate stitching across sections and tile boundaries at sub-micrometer resolutions, which in turn increases the complexity and cost of downstream image analysis.

Because light aberration and scattering limits high-resolution microscopy in tissue to depths of hundreds of micrometers, sectioning and tiling have traditionally been viewed as necessary to image large specimens. However, advances in histological methods, including clearing and expansion for microscopy (ExM), now promise diffraction-limited imaging deep in tissue. Avoiding sectioning and reducing tiling involves overcoming the volumetric imaging barrier of microscopy (i.e., the maximum volume that may be imaged). Expansion up to a factor of 20 has been demonstrated, providing access to molecular spatial scales (tens of nanometers) approaching those of cryoEM (a few nanometers). These ExM methods produce large, fragile three-dimensional samples, further emphasizing the need for overcoming the volumetric imaging barrier.

### SUMMARY

Expansion-Assisted Selective Plane Illumination Microscopy (ExA-SPIM) combines a new microscope and methods for tissue clearing and expansion to address shortcomings of other imaging techniques. Leveraging optics and detectors developed for the electronics metrology industry, ExA-SPIM has a field of view about 100 times larger (e.g., 13.3 mm diameter) and a working distance about ten times larger (e.g., 35 mm) than objectives typically used for biological microscopy, while retaining a relatively high numerical aperture (NA) (e.g., 0.305). When combined with the expansion of large tissue volumes, such as a mouse brain, an ExA-SPIM system achieves near-isotropic effective optical resolution of about 300 nm laterally and about 800 nm axially (i.e., the axial resolution is less than three times the lateral resolution) at imaging speeds of up to 1 gigavoxel/second. Tailoring the expansion factor allows fine tuning the effective resolution for specific tissue types and scientific questions.

ExA-SPIM is particularly well suited for imaging and reconstructing mammalian neurons. Axonal arbors of individual neurons are complex, branched structures that transmit electrical impulses over distances of centimeters, yet axons can be thinner than 100 nm. Axons contain numerous varicosities that make synapses with other neurons. Tracing the axonal arbors of single neurons is useful for determining how signals are routed within the brain and for classifying diverse neuron types into distinct types. Large-scale projects based on single cell transcriptomics in the mouse and human brain have revealed a great diversity of neuron types.

However, the throughput of neuronal reconstructions has remained too low for single neuron reconstructions on a comparable scale, even in mice. Throughput is limited in part by cumbersome and error-prone microscopy methods, which make the downstream segmentation and reconstruction of axonal arbors difficult and time-consuming. ExA-SPIM provides high-resolution fluorescence microscopy over teravoxel image volumes with minimal distortions, and thereby enables brain-wide imaging with high contrast and resolution.

ExA-SPIM can be implemented as a light sheet imaging system for imaging a biological sample, such as an optically cleared and/or expanded tissue. This light sheet imaging system includes first and second objective lenses, an immersion chamber, and a detector (e.g., a >100 Megapixel detector). The first objective lens is in optical communication with the biological sample and illuminates a selected location within the biological sample with a light sheet. The second objective lens has an étendue of at least 8 mm², a numerical aperture of at least 0.10, a Strehl ratio >0.8 when imaging through optical glass with a predetermined thickness greater than 10 mm (e.g., 25 mm or 35 mm), and a Strehl ratio <0.8 when imaging purely in air. The second objective lens is also in optical communication with the biological sample and collects fluorescence emitted by the biological sample in response to the light sheet. The immersion chamber is in optical communication with the first and second objective lenses and holds the biological sample in a liquid medium having a refractive index within 0.1 of the refractive index of the biological sample across a spectrum of the fluorescence. And the detector is in optical communication with the second objective lens and detects the fluorescence collected by the second objective lens.

The second objective lens can be a finite conjugate lens. It can be configured or arranged to detect the fluorescence through a window in the immersion chamber. The second objective lens can be aligned perpendicular to the window to reduce optical aberrations.

The liquid medium can have a refractive index from about 1.2 to about 1.7. Its refractive index within about 0.1 of a refractive index of the biological sample.

The system can also include a filter, in optical communication with the biological sample, the second objective lens, and the detector, to prevent light at a wavelength of the light sheet from illuminating the detector. It can also include a kinematic mount, mechanically coupled to the second objective lens, to align the second objective lens with respect to the biological sample. And it can include a processor, operably coupled to the detector, to generate a fluorescence image based on the fluorescence.

ExA-SPIM can be implemented as a method of imaging a biological sample (e.g., mammalian brain tissue, such as human brain tissue) immersed in a liquid medium. This method can include illuminating the biological sample with a light sheet via a first objective lens. A second objective lens collects fluorescence emitted by the biological sample in response to the light sheet through the liquid medium and through air. The second objective lens has an étendue of at least 8 mm², a numerical aperture of at least 0.10, a Strehl ratio >0.8 when imaging through optical glass with a predetermined thickness greater than 10 mm, and a Strehl ratio <0.8 when imaging purely in air. A sensor detects the fluorescence collected by the second objective lens. This fluorescence is used to generate an image of the biological sample based on the fluorescence.

Another ExA-SPIM implementation includes an immersion chamber, excitation source, finite conjugate lens, and detector, The immersion chamber holds a biological sample within a liquid having a refractive index within 0.1 of the biological sample at a fluorescence wavelength. The excitation source is in optical communication with the immersion chamber and illuminates a selected location within the biological sample with a light sheet. The finite conjugate lens is in optical communication with the immersion chamber and is spaced apart from the biological sample by at least 10 mm of the liquid and at least 1 mm of air. The finite conjugate lens may have a numerical aperture greater than 0.1 (e.g., 0.15, 0.2, 0.25, 0.3, or greater) and a working distance of 10 mm or more (e.g., 10 mm, 15 mm, 20 mm, 25 mm, 30 mm, or 35 mm). In operation, the finite conjugate lens forms a diffraction-limited image of fluorescence emitted by the biological sample at the fluorescence wavelength in response to the light sheet. And the detector, which is in a back focal plane of the finite conjugate lens, detects the diffraction-limited image.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A is a plot of imaging volume versus resolution for expansion-assisted imaging approaches.

FIG. 1B is a plot of field of view versus numerical aperture for different types of imaging lenses for fluorescence imaging.

FIG. 2A illustrates an Expansion-Assisted Selective Plane Illumination Microscopy (ExA-SPIM) system.

FIG. 2B illustrates a mechanical layout for the ExA-SPIM system, with renderings at right showing the detection assembly, illumination assembly, chamber assembly, and stage assembly.

FIG. 2C illustrates a multi-wavelength excitation source for an ExA-SPIM system.

FIG. 3 shows positioning and performance differences between the detection objective in the ExA-SPIM system and other lenses.

FIG. 4 illustrates center and field edge point spread functions (PSFs) of the detection objective in the ExA-SPIM system.

FIG. 5 illustrates axially swept light-sheet microscopy with the ExA-SPIM system.

FIG. 6A illustrates tip-tilt adjustment of the detection objective with respect to the immersion chamber, e.g., using a kinematic mount.

FIG. 6B illustrates axial adjustment of the detection objective with respect to the immersion chamber, e.g., using a kinematic mount and/or rail system.

FIG. 7 illustrates fluorescence filters on the object or image sides of the detection objective.

FIG. 8A illustrates inverted ExA-SPIM.

FIG. 8B illustrates open-top ExA-SPIM.

FIGS. 9A-9C illustrate an immersion chamber suitable for use in an ExA-SPIM system.

FIG. 10A illustrates imaging of an expanded mouse brain in 15 tiles by an ExA-SPIM system.

FIG. 10B illustrates point spread function (PSF) measurements of an example ExA-SPIM system.

FIG. 10C shows plots of field curvature (left) and distortion (right) for an example ExA-SPIM system.

FIG. 10D is a plot of relative signal-to-noise ratio (rSNR) versus imaging speed for an ExA-SPIM with different image sensors.

FIG. 11A illustrates a workstation for controlling an ExA-SPIM system.

FIG. 11B illustrates an ExA-SPIM image acquisition pipeline.

FIGS. 12A-12K illustrate nanoscale imaging of entire intact mouse brains with an ExA-SPIM system. FIGS. 12A and 12B are nanoscale images of sparsely labeled neurons in intact, expanded mouse brains acquired with an ExA-SPIM system. FIG. 12C shows single neurons traced and reconstructed from the imaging data in FIGS. 12A and 12B. FIG. 12D shows adjacent imaging tiles from FIGS. 12A and 12B aligned in overlapping regions thanks to a lack of sectioning, stable specimen mounting, fast imaging times, and minimal imaging distortions. FIGS. 12E-12H are close-ups of individual dendritic spines with near-isotropic resolution. FIGS. 12I-12K are close-ups of axonal varicosities with near-isotropic resolution. The images are displayed as maximum intensity projections with the following thicknesses: 26 mm (FIG. 12B), 2 mm (FIG. 12D), 1 mm (FIGS. 12E-12H), and 100 μm (FIGS. 12I-12K).

FIGS. 13A-13F illustrate expansion and imaging of a large volume of macaque brain with an ExA-SPIM system. A 1×1×1.5 cm block of macaque primary motor cortex was expanded (3×) and imaged on the ExA-SPIM. Corticospinal neurons were transduced by injecting tdTomato-expressing retro-AAV into the spinal cord. FIGS. 13A and 13B are maximum intensity projections of the imaged volume pseudo colored by depth. The axes descriptors in FIG. 13A indicate the 5×3 tiling used to image this volume. FIGS. 13C-13F show fine axonal and dendritic structures including descending axons, collaterals and dendritic spines are clearly discernable in the images throughout the entire volume. Images are displayed as maximum intensity projections with the following thicknesses: 23 mm (FIG. 13A), 45 mm (FIG. 13B), and 1 mm (FIGS. 13C-13F).

FIGS. 14A-14F illustrate ExA-SPIM imaging of human tissue. FIGS. 14A and 14B show a region from the medial temporal-occipital cortex that was manually dissected into a ~1×1 cm block, which was subsequently sectioned into ~100 μm sections for tissue expansion (4×), labeling, and ExA-SPIM imaging. FIGS. 14C and 14B show maximum intensity projections of a region of interest from white and gray matter, pseudo-colored by depth. FIGS. 14E and 14F show individual axons and their trajectories are clearly resolved with high contrast. Images are displayed as maximum intensity projections across 350 μm in FIGS. 14B-14F.

### DETAILED DESCRIPTION

Recent breakthroughs in histological methods, fluorescent labeling strategies, fast and sensitive cameras, and new microscopes are revolutionizing our ability to study the molecular organization of cells and tissues with fluorescence microscopy. For many applications it is beneficial to reconstruct tissues with high resolution and contrast over large spatial scales, including cells, organs, or even entire organisms. For example, such multi-scale imaging is used to reconstruct individual neurons in the mouse brain, which can span many millimeters, but with axons that are often less than 100 nm thick.

Expansion-assisted selective plane illumination microscopy (ExA-SPIM) leverages technologies from the electronics metrology industry, in combination with whole-mount tissue expansion, to provide: (1) nanoscale lateral resolution, (2) over large centimeter-scale volumes, (3) with minimal tiling and no sectioning, (4) high isotropy, and (5) fast imaging speed. ExA-SPIM uses a detection objective lens designed to image through a >10 mm thick (e.g., 25 or 35 mm thick) glass block with a Strehl ratio of >0.8 (e.g., 0.85, 0.9, 0.95, 0.99, or higher) and an étendue of >0.1 (e.g., 0.15, 0.2, 0.25, 0.30, or higher). Because this lens is designed to image through a relatively thick piece of optical glass, its aberration performance degrades considerably when imaging in air (e.g., its Strehl ratio is <0.8 when imaging purely in air), so in an ExA-SPIM system it is arrange to image a sample or specimen in liquid through a combination of air, glass, and liquid whose aggregate optical thickness is roughly equal to the optical thickness of the absent optical glass.

ExA-SPIM relies on whole-mount tissue expansion, which provides submicrometer resolution, low fluorescent background, and optically clear specimens. ExA-SPIM enables centimeter-scale tissues to be imaged with sub-micrometer resolutions at up to 1 gigavoxel/sec. The large imageable volume dramatically reduces the need for physical sectioning and tiling, both of which can severely compromise imaging data and create major challenges for downstream image analysis.

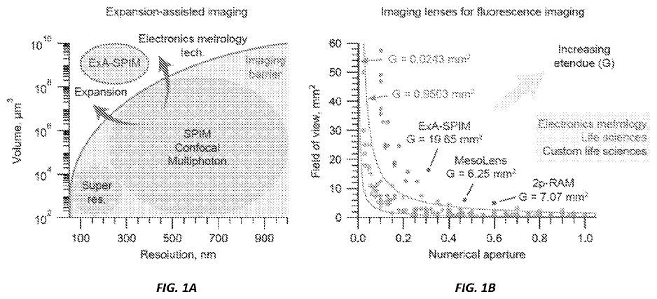

FIG. 1A shows that reducing the need for physical sectioning and tiling allows ExA-SPIM to overcome the volumetric imaging barrier (thick line) that bounds current fluorescence microscopy approaches. More specifically, FIG. 1A is a plot of the maximum volume that may be imaged at a given spatial resolution for different expansion-assisted imaging techniques. Conventional selective plane illumination microscopy (SPIM) is limited by the diffraction limit and the specifications of microscope objectives for life sciences. ExA-SPIM surpasses these limits using tissue expansion and leveraging highly engineered lenses from the electronics metrology industry as explained below.

An ExA-SPIM system can detect and resolve dim, nanoscale biological features with high signal-to-noise ratio (e.g., thin axons). Because of the ExA-SPIM system's large field of view, high SNR imaging is achieved with 1000+ mW lasers, which produce modest light intensities because the power is distributed over a roughly 1 cm wide light sheet. Under these imaging conditions photobleaching is negligible, suggesting that even higher laser intensities could be used for higher SNR imaging. Increasing the numerical aperture of the ExA-SPIM system's detection objective lens increases signal collection and enables even higher sensitivity without sacrificing étendue or working distance. For instance, a detection objective lens with an NA of 0.5-0.6 enables ~125 nm effective lateral resolution in 4× expanded tissues, with 5× improved light collection efficiency.

An ExA-SPIM system is useful for many imaging applications, including the combination of microscopy with tissue expansion. For example, the field of view of the ExA-SPIM is sufficient to image a cleared mouse brain without the need for tiling. An ExA-SPIM system can acquire cleared mouse brain datasets with an approximate lateral resolution of 1 μm could be acquired at a speed of about 36 min/channel. In addition, the entire ExA-SPIM system could be converted to an inverted or open-top architecture, which would enable large-scale imaging of tissue slabs with large aspect ratios that are up to 1 cm thick. Such a system could pave the way for new large-scale neuroanatomy investigations of human and non-human primate tissues.

Étendue and Volumetric Imaging Limits

A fluorescence microscope for large-scale tissue imaging should provide: (1) nanoscale resolution, (2) over centimeter-scale volumes, (3) with minimal tiling and sectioning, (4) high isotropy in resolution and contrast, and (5) fast imaging speed. The choice of microscope objective imposes trade-offs between the smallest objects that can be resolved (the resolution), how much of the specimen can be observed at once (the field of view), and how thick of a specimen may be imaged (the working distance). These trade-offs reflect limitations of optical design, engineering, and lens manufacturing. The trade-off between resolution and field of view is related to the étendue (G), which is proportional to the number of resolution elements of an optical system. The étendue is a quadratic function of the lens field of view (FOV) and numerical aperture (NA):

$$G = \frac{π}{4} {( F O V \times N A )}^{2} .$$

90% of commercially available objectives for biological microscopy have G<1 mm².

Several attempts have been made to develop custom lenses for specific applications. The ‘Mesolens’ provides an étendue of G=6.25 mm², with a FOV=6 mm and NA=0.47, but difficulties with manufacturing have limited adoption. An objective with an étendue of G=7.07 mm², FOV-5 mm, and NA=0.6 has been developed for so-called a two-photon random-access mesoscope (2p-RAM). However, this lens is customized for infrared illumination and exhibits significant field curvature, so it is unsuitable for large-scale volumetric fluorescence microscopy.

ExA-SPIM exploits aspects of high-resolution, high-speed imaging used for machine vision and metrology, where optical microscopes are used to map defects in semiconductors and other electronic devices. As the physical size of electronic components (e.g., pixels on flat panel displays) have become smaller, lenses for machine vision and metrology have been designed with increasing NA, accessing biologically relevant resolutions (e.g., <1 μm). For a given NA these lenses have remarkably large field of views (and thus high étendues), low field curvature, minimal distortion, and chromatic correction throughout the visible wavelengths.

ExA-SPIM uses a lens and camera sensor originally designed for electronics metrology in an appropriately modified optical system for imaging biological tissue at fine spatial resolution over large working distances (e.g., 10 mm, 15 mm, 20 mm, 25 mm, 30 mm, or 35 mm). The electronics metrology lens is a finite conjugate lens normally used with a glass beam splitter, which may be 25 mm or 35 mm thick, for co-axial illumination of the electronics it is being used to image. The electronics metrology lens has an NA>0.1 (e.g., 0.15, 0.2, 0.25, 0.3, or higher) and offers nearly aberration-free imaging (e.g., a Strehl ratio of 0.8, 0.85, 0.9, 0.95, or higher) when imaging through the glass beam splitter. Unfortunately, the electronics metrology lens's imaging performance is much poorer when imaging through air alone (e.g., a Strehl ratio of <0.8). To compensate for the absence of the glass beam splitter, the electronics metrology lens is arranged to image the specimen or sample, which is immersed in liquid, through a combination of air, transparent material (e.g., glass or plastic), and liquid whose optical thickness is (approximately) equivalent to that of the glass beam splitter. For example, there may be at least 10 mm (e.g., 12.5 mm, 15 mm, 17.5 mm, 20 mm, or 22.5 mm) of liquid and at least 1 mm (e.g., 2.5 mm, 5 mm, 7.5 mm, 10 mm, 12.5 mm, 15 mm, 17.5 mm, or 20 mm) of air between the lens and the sample, plus the thickness of the glass or plastic window in the immersion tank (e.g., 1 mm, 2 mm, 3 mm, 4 mm, or 5 mm). This enables spherical aberration-free imaging with a working distance up to 35 mm deep into aqueous samples, including expanded hydrogels.

FIG. 1B shows a comparison of étendue between electronics metrology lenses and life sciences lenses. The étendue (G) of 90% of life sciences objectives (shaded region in FIG. 1B) is bounded by 0.0243 mm²<G<0.9503 mm², apart from custom lenses, such as the Mesolens (G=6.25 mm²) and 2p-RAM lens (7.07 mm²). In contrast, lenses developed for electronics metrology can have G>10 mm². The lens used in the example ExA-SPIM system demonstrated here provides a field of view of 16.8 mm² with NA=0.305 (G=19.65 mm²).

### An Expansion-assisted Selective Plane Illumination Microscopy (ExA-SPIM) System

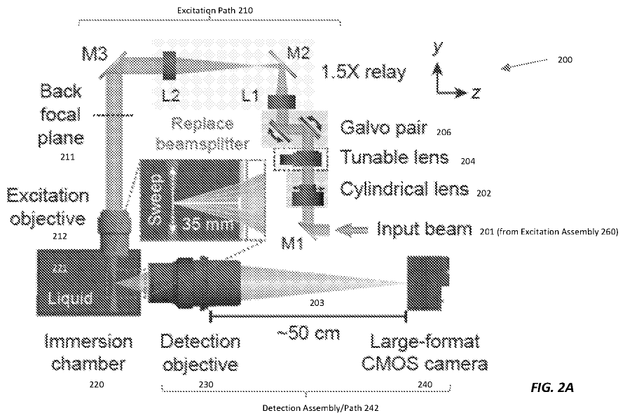

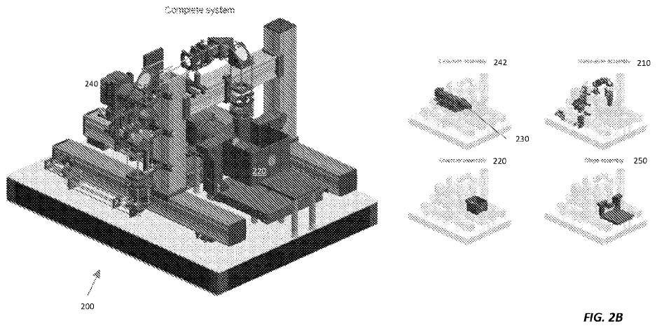

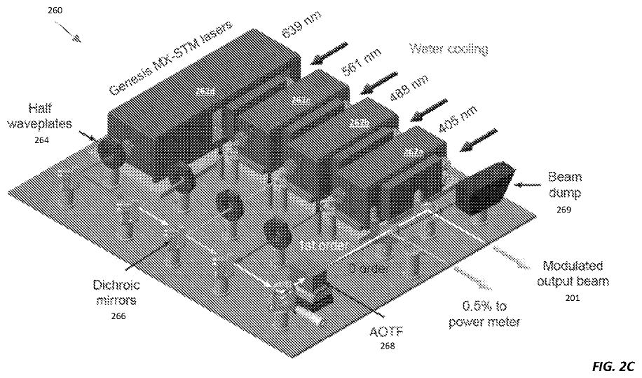

FIGS. 2A-2C illustrate an example ExA-SPIM system 200, which includes an illumination assembly 210, immersion chamber 220, detection assembly 242, and stage assembly 250. The immersion chamber 220 holds the specimen being imaged in liquid 221, which has a refractive index of about 1.2 to about 1.7 (e.g., about 1.3, 1.4, 1.5, or 1.6). The liquid's refractive index may be within about 0.1 or less (e.g., 0.05, 0.04, 0.03, 0.02, or 0.01) of the specimen's refractive index.

FIG. 2C shows an excitation assembly 260 that produces laser light 201 using to excite fluorescence from the specimen. The excitation assembly 260 includes a 200 mW, 405 nm laser 262a; 1000 mW, 488 nm laser 262b; 1000 mW, 561 nm laser 262c; and 1000 mW, 639 nm laser 262d (collectively, lasers 262). Respective half wave plate 264 rotate the polarizations of the beams emitted by the lasers 262. Dichroic mirrors 262 combine the beams and direct them to an acousto-optic tunable filter (AOTF) 268, which is controlled by a radio-frequency (RF) driver (not shown). The AOTF 268 modulates the combined laser beams and controls the wavelength and output power of the modulated output beam 201. The 0-order beam from the AOTF 268 terminates in a beam dump 269, whereas the modulated 1st order beam 201 is reflected off a final kinematic mirror before being injected into the microscope. An AR-coated glass plate is used to reflect about 0.5% of the output beam to a power meter (not shown) for monitoring during dataset acquisition. Due to the large light-sheet, the ExA-SPIM system 200 benefits from high excitation lasers powers (e.g., 1000+mW), resulting in light intensities typically used in SPIM microscopy. Photobleaching is negligible at these imaging conditions.

FIGS. 2A and 2B show the illumination assembly 210, which shapes and delivers the laser light 201 to the specimen as a light sheet. It includes an achromatic cylindrical lens 202 that focuses the laser light 201, which has a diameter of about 13.3 mm, along one axis to produce a light sheet for exciting fluorescence from the sample. The cylindrical lens 202 is mounted in a motorized rotation mount. This enables precise electronic control over the rotation of the light sheet within the specimen. Control over this parameter allows the light sheet to be rotated with <1° precision, which is helpful given the desired field of view (about 10.6 mm) and depth of focus of the detection lens (<10 μm) for the light sheet.

The cylindrical lens 202 focuses light onto an electrically tunable lens 204. The actuating surface of the electrically tunable lens 204 is conjugated to the back focal plane 211 of an excitation objective 212 through two large 20 mm galvanometric scanning mirrors 206, three additional kinematic mirrors M1, M2, and M3, and a final relay consisting of a first lens L1 with f=200 mm and second lens L2 with f=300 mm. The two galvanometric mirrors 206 are not conjugated to the back focal plane 211 of the excitation objective 212 and are used in tandem to tilt and translate the light sheet to be co-planar with the detection lenses' focal plane. Similar to the cylindrical lens rotation 202, the light sheet should be tilted to <1° precision across the approximately 8.0 mm height of the imaging field of view.

In this example, the excitation objective 212 has a focal length of f=110 mm, NA=0.133, and back aperture diameter of about 29.26 mm, which, with the other excitation optics, produces a Gaussian excitation light sheet with NA of about 0.1. The excitation lens 212 is infinity-corrected (to enable axially swept excitation) and provides diffraction-limited resolution over a 16 mm field of view. The beam shaping in the excitation path 210 is configured to deliver a light sheet with NA=0.10 and width of 12.5 mm (full-width half-maximum) to the sample.

The intensity profile across the width of the light sheet was also Gaussian, with a full-width half-maximum (FWHM) of about 12.5 mm. This corresponds to a reduced (60%) light intensity at the edges of the field of view. The excitation objective 212 is mounted in a dipping cap which extends the effective working distance from 39 mm in air to about 52 mm in water. The 1-mm thick window on the dipping cap is sealed with UV curing optical adhesive. The excitation objective 212 is oriented vertically, such that the light sheet is delivered downward to the sample (not shown) in the immersion chamber 220, which is filled with the immersion medium 221.

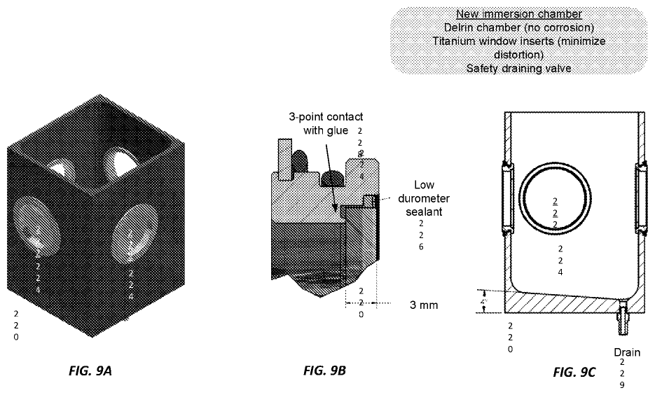

FIGS. 9A-9C show the immersion chamber 220, which has λ/10 50 mm diameter VIS-EXT coated fused silica windows 222, each 3 mm thick, on its faces. Each window 222 is glued to the immersion chamber 220 using UV-curing optical adhesive 228 at three contact points. Low durometer sealant 226 seals the outer circumference of the retaining ring 224. A 44 mm diameter 1 mm thick multi-bandpass fluorescence filter (not shown) can be inserted on the outer side of the immersion chamber 220 and held in place with a retaining ring 224. Placing the filter on the object side of the lens results in a cone angle of incidence of 17.8 deg. This results in a spectral shift and broadening of transmitted light, which can be modeled to account for adequate suppression of scattered light at the excitation laser wavelengths. The specimen (not shown) can be mounted inside the immersion chamber 220 in a holder (not shown) that is attached to a motorized three-axis translation stage (not shown; typically mounted outside the immersion chamber 220) for scanning and tiling-based image acquisition. The immersion chamber 220 is filled with immersion fluid 221, which can be emptied from the immersion chamber 220 via a drain port 229 in one corner.

A high étendue detection objective lens 230 in the detection assembly 242 collects the fluorescence emitted through the window 222 of the immersion chamber 220 by the sample in response to the light sheet. In the example described here, the detection objective lens 230 is a VEO JM DIAMOND 5.0×/F1.3 industrial lens from Vieworks with a NA=0.305, a 16.8 mm field of view, and an etendue G=19.65 mm² that provides diffraction-limited imaging at 5.0× magnification.

This detection objective lens 230 is a finite conjugate lens originally designed for co-axial illumination through a 35 mm thick BK7 glass (n=1.52) beam splitter (not shown) mounted on its object side. (The beam splitter couples white light into the lens for bright illumination of electronic components during inspection.) Unfortunately, simply imaging through air with the detection objective lens 230 would produce severe spherical aberration as shown in the middle of FIG. 3. Likewise, using the dipping cap from the excitation objective lens 212 with the detection objective lens 230 would result in severe spherical aberration as shown at left in FIG. 3 due to the detection objective lens's larger numerical aperture (NA=0.305).

We removed the beam splitter and replaced it with an optically equivalent thickness of the aqueous mounting medium 221 (35 mm) and glass (4 mm total, including the window 222 in the immersion chamber 220 and fluorescence filter, both described below). This scheme avoids the spherical aberrations that would otherwise plague imaging with an air-immersion lens into a non-air-based medium as shown at right in FIG. 3. The detection objective lens 230 is positioned horizontally on the optical table outside of the immersion chamber 220.

As shown in FIGS. 4 and 5, the detection objective lens 230 is attached to an image sensor 240 with one or more lens tubes 232. There may also be one or more filters in the detection path to prevent excitation light from reaching the image sensor 240, for example, on the object (specimen) side of the detection objective lens 230 like filter 236 or the image (sensor) side of the detection objective lens 230 like filter 234 as in FIG. 7. A filter can also be coated onto the window 222 of the immersion chamber 220 through which the detection objective lens 230 detects the fluorescence or on one or more of the optical surfaces of the detection objective lens 230 itself.

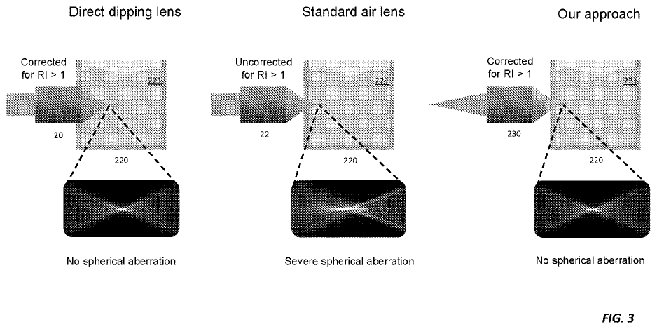

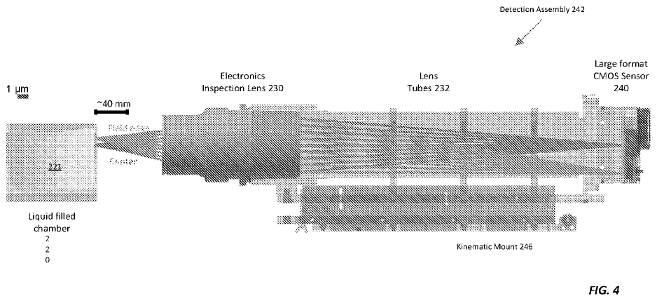

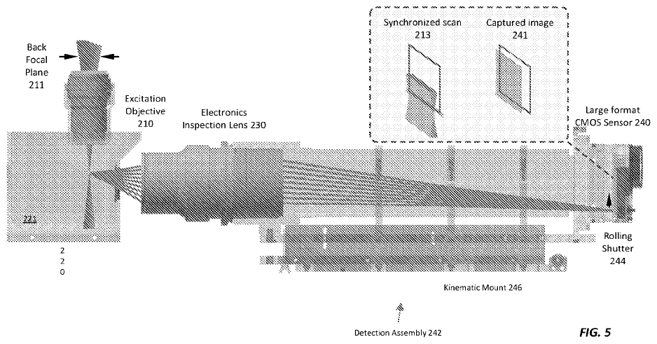

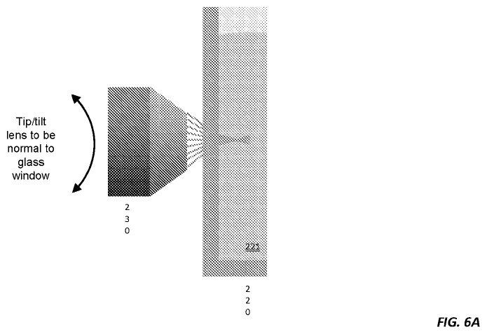

The detection objective lens 230, lens tubes 232, and image sensor 240 are mounted on a kinematic mount 246 that enabled tipping and tilting of the detection objective lens 230 and image sensor 240 relative to the immersion chamber 220 as shown in FIG. 6A. The kinematic mount 246 can provide fine axial alignment of the detection objective lens 230 and image sensor 240 with respect to the immersion chamber 220 as shown in FIG. 6B. If desired, the detection objective lens 230 and image sensor 240 (and possibly the kinematic mount 246) can be mounted on a rail system (not shown) that enables precise axial alignment relative to the immersion chamber 220. The detection objective lens 230, lens tubes 232, and image sensor 240 can be aligned to the window 222 of the immersion chamber 220 using an alignment laser, the kinematic mount 246, and the rail system.

In the examples given here, the image sensor 240 is a large-format image sensor 240 with a single-sided rolling shutter 244, 151 megapixels, 14192 (H)×10640 (V), and a pixel pitch of 3.76 μm. The 5.0× magnification of the detection objective lens 230 implies sampling at 0.75 μm in the specimen plane (inside the immersion chamber 220). Because the detection objective lens 230 is not infinity-corrected, it is not possible to change tube lenses to change the pixel size. An image sensor with pixel-shifting technology could enable finer sampling.

The image sensor 240 can be operated with 12-, 14-, or 16-bit analog to digital (A/D) conversion, each of which provides a trade-off between noise and data throughput. When operated with 14-bit A/D, the line time of the image sensor 240 is 20.15 μs. With 14,192 pixels per row on the image sensor 240, this corresponds to an imaging speed of 703×106 voxels/sec. This contrasts with a state-of-the-art sCMOS sensor with 2048 pixels per row, where even at the fastest 4.89 μs line time, the imaging speed is only 418×10⁶ voxels/sec. In other words, the image sensor 240 provides more pixel parallelization within each row. This enables twice the voxel rate with four times the pixel dwell time.

To improve axial resolution, the ExA-SPIM system 200 synchronizes an axially swept light-sheet with the rolling shutter 244 of the image sensor 240 as shown in FIG. 5. The image sensor 240 parallelizes readout across 14,192 pixels per row, thereby achieving equivalent or greater pixel rates than typical scientific CMOS (sCMOS) sensors, even with an increased time per line and a relatively low frame rate (e.g., 6.4 Hz). As a result, the ExA-SPIM system 200 operates at a higher imaging speed with comparable signal-to-noise ratio (SNR) to sCMOS-based systems. The low frame rate of the image sensor 240 facilitates accurate axially swept imaging using generic scanning hardware at an imaging speed of up to 1 gigavoxel/sec.

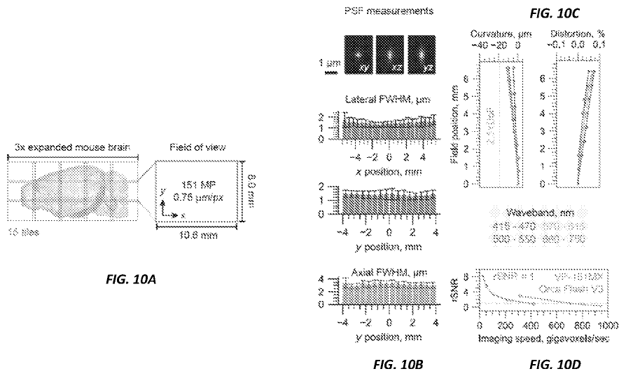

Based on the excitation objective lens 212, the detection objective lens 230, and the travel limits of the kinematic mount 246 and rail system, the ExA-SPIM system 200 can image a 200×52×35 mm³ volume, with 1 μm lateral and roughly 2.5 μm axial native optical resolution, and minimal field curvature and distortion as shown by FIGS. 10B-10D and explained in greater detail below. We leveraged this large volume to image intact tissues which were expanded in all three dimensions as described below.

Tuning the expansion factor allows tuning the effective resolution for specific biological applications. With threefold tissue expansion, the ExA-SPIM system 200 can image a native tissue volume of 67×17×12 mm³ with an effective optical resolution of 300 nm laterally and 800 nm axially. This amounts to >100 teravoxels, which can be captured without physical sectioning and with minimal tiling.

### Alternative ExA-SPIM Architectures

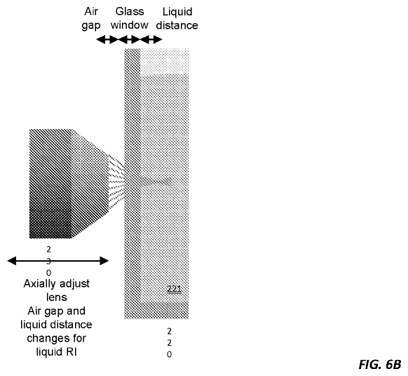

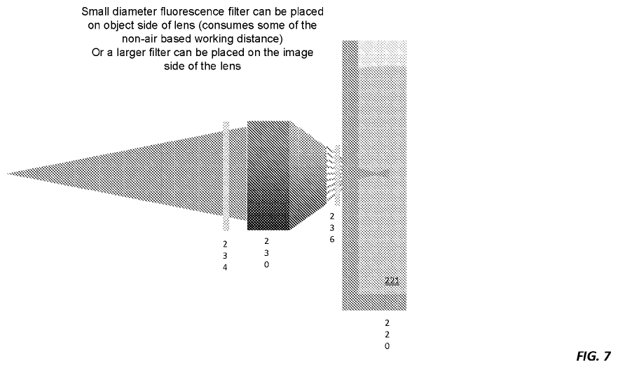

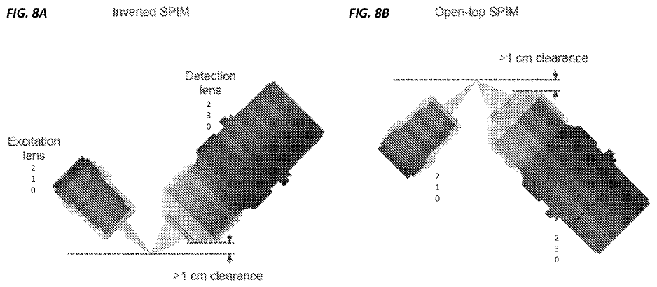

FIGS. 8A and 8B show inverted and open-top ExA-SPIM architectures, respectively. In both geometries, the working distance and mechanical housing of the lenses provides >1 cm of clearance, enabling imaging large tissue sections up to 1 cm thick. This geometry also reduces pathlengths through the tissue, reducing the demands on optical clearing and tissue clarity.

### ExA-SPIM Optical Performance

FIGS. 10A-10D illustrate the optical performance of the example ExA-SPIM system 200 described above. The image sensor 240 captures a field of view of 10.6×8.0 mm, capable of covering an entire 3× expanded mouse brain in only 15 tiles as shown in FIG. 10A. A conventional SPIM system would need 400+ tiles to image an entire cleared brain at equivalent resolutions.

FIG. 10B illustrates point spread function (PSF) measurements of the ExA-SPIM system 200. To quantify the PSF, we imaged fluorescent 0.2 μm TetraSpeck™ microspheres. A cube of expanding hydrogel containing a 10% (v/v) microbead soluton was prepared 40 μL of microspheres solution was added to 360 μL of activated Stock X monomer solution, as described in (Asano et al. 2018). The solution was briefly vortexed, and carefully pipetted into an array of 2 mm³ wells in a silicone mold. The mold was placed in a sealed petri dish containing damp Kimwipes® to maintain humidity and incubated at 37 °C for two hours. After incubation, the polymerized bead phantoms were placed into 0.05×SSC buffer for at least 24 hours to expand and equilibrate prior to imaging. After volumetric imaging, the resulting imaging stack was analyzed to produce the PSF measurements. The results in FIG. 10B are averaged from >10,000 individual beads.

FIG. 10C (left plot) shows the field curvature of the ExA-SPIM system as measured using a high-precision Ronchi ruling with 120 lines per mm. The Ronchi ruling was mounted into the ExA-SPIM system and aligned to be normal (i.e., flat) with respect to the imaging path. The Ronchi ruling was trans-illuminated using light-emitting diodes (LEDs) at 450 nm, 530 nm, 595 nm, and 660 nm. To provide uniform illumination, the LEDs were collimated to a diameter of about 20 mm and passed through a diffuser. Image stacks were captured by scanning the Ronchi ruling in 1 μm steps through the imaging path focal plane (2 mm total scan range) with illumination at either 450 nm, 530 nm, 595 nm, or 660 nm. The resulting image stack was split into a 16×16 grid of regions of interest (ROI), each 887×665×2000 pixels. Within each ROI, the contrast of each frame in the stack was calculated using the 5th and 95th percentiles of intensity within the frame, where the contrast, C=(Iₘₐₓ−Iₘᵢₙ)/(Iₘₐₓ+Iₘᵢₙ). The resulting contrast versus depth curve was fit to a normal distribution to extract the depth (i.e., index) corresponding to maximum contrast. The indices were radially averaged across the 16×16 grid of ROIs, yielding an estimate of the imaging lens field curvature within each of the four tested wavebands.

The right plot in FIG. 10C shows the ExA-SPIM system's lens distortion, which was measured using a target with 125 μm diameter dots spaced every 250 μm in a grid pattern. The target was mounted and trans-illuminated using LEDs in the same manner as the field curvature quantification. A single image was acquired with the target at the focal plane of the imaging lens (e.g., the detection objective lens 230 in FIG. 2A). The resulting image was quantified by first segmenting and calculating the centroid of each dot. The calculated position of each dot was then compared to the theoretical dot position. The percent distortion for each dot was defined as the difference between the experimental and theoretical positions, normalized by the theoretical position. The resulting distortion values were radially averaged, yielding the lens distortion as a function of position from the center of the lens field of view.

FIG. 10D is a plot of relative signal-to-noise ratio (rSNR) versus imaging speed for the image sensor 240 (here, a Sony VP-151MX, right trace) and a scientific CMOS camera (in this case, an Orca Flash V3 from Hamamatsu, left trace). A bead phantom (see point spread function measurement) was used to compare the sensitivity of the image sensor 240 and the scientific CMOS camera. A single bead was first imaged with the scientific CMOS camera in place of the image sensor 240 in the ExA-SPIM system while varying the effective pixel rate or imaging speed. The scientific CMOS camera was then removed from the ExA-SPIM system and replaced with the image sensor 240 (large-format CMOS camera). The same bead was located and imaged again at various effective pixel rates using the image sensor 240. The bead was located in all image stacks, and the rSNR of the bead was quantified as the signal of the bead, minus the average background signal, divided by the background noise.

### ExA-SPIM Workstation Control

FIG. 11A illustrates a workstation 1000 for controlling image acquisition and processing with the ExA-SPIM system 200. The workstation 1000 has a motherboard 1010 with five PCIe 4.0×16 and one PCIe 4.0×8 slots, most of which are used for the electronics that control the ExA-SPIM system 200. One slot is used for a frame grabber 1012, which streams imaging data from the image sensor 240 onto a fast local non-volatile memory express (NVME) drive 1020. A second slot is used for a data acquisition (DAQ) card 1014 used for generating the various digital and analog voltage signals. A third slot is used for a high-speed network interface card (NIC) 1016 to transfer data off the local NVME drive 1020, over a network, and onto a networked storage server 1040. A fourth slot is occupied by the workstation's graphics processing unit (GPU) 1018.

The workstation 1000 is also connected to a controller 1030 via a universal serial bus (USB) connection 1002. The controller 1030 is equipped with cards for controlling the motorized X, Y, and Z stages, the electrically tunable lens 204, and the cylindrical lens rotation mount. Each laser 262 within the excitation assembly 260 (FIG. 2C) is connected to the workstation 1000 via a USB connection (not shown), as well as the RF driver of the AOTF 268. The DAQ card 1014 acts as the master controller of the entire ExA-SPIM system. Analog output voltages from the DAQ card 1014 drive or trigger the electrically tunable lens 204, two scanning galvanometric mirrors 206, image sensor 240, kinematic mount 246, and the RF outputs to the AOTF 268 for each laser 262 (FIGS. 2A and 2C).

FIG. 11B shows an acquisition pipeline executed with the workstation 1000 for the ExA-SPIM system. The workstation 1000 runs software for controlling and configuring of the electronically controlled hardware devices and a graphical user interface (GUI) for image streaming and visualization. An imaging experiment includes a series of nested loops, including loops (1001) over the total number of frames within a given tile, loops (1003) over the total number of channels within a tile, and finally tiling in two dimensions to cover the entire tissue volume. Put differently, acquiring each dataset involves looping over the total frames within a given tile, and then all tiles within that dataset.

A multiprocessing, double buffering scheme captures a tile while the previous tile is being transferred over the network to longer term storage (e.g., storage server 1040). Each tile results in a single file on disk, which is copied over the network to the local storage server 1040. The transfer of the previous tile occurs synchronously with the acquisition of the next tile, and the transfer speed to the local storage server 1040 outpaces the data generation speed of the ExA-SPIM system. For the ImarisWriter workflow, once tiles are transferred to the local storage server 1040, they are synchronously converted to OME-Zarr files with ZSTD Shuffle compression. After compression, the files are written directly to cloud storage 1042. The compression and conversion to OME-Zarr also runs at a speed which outpaces the ExA-SPIM system.

The ExA-SPIM system uses two strategies to achieve robust and reliable acquisition at the desired speed. The first uses the open-source eGrabber frame grabber Python API10 and open-source ImarisWriter library 1052. This option enables high-speed data streaming with online lossless compression (LZ4 with bit shuffling) and real-time writing of a multi-resolution pyramid, both of which help streamline downstream data storage and handling. The second strategy uses Acquire 1054, led by the Chan Zuckerberg Initiative Imaging team in collaboration with the Allen Institute for Neural Dynamics. Acquire 1054 is a new state-of-the-art microscope acquisition project which enables the ExA-SPIM system to stream data at the desired rate, directly to OME-Zarr, with either ZStandard or LZ4 compression, and a variable chunk size.

On average, with the 14-bit A/D setting of the image sensor (MSB packed into 16 bits), the lossless compression ratio using either ImarisWriter or Acquire is about 2-4×. This reduces the ExA-SPIM system's overall effective data rate and eases network transfers of the data to centralized storage.

Data is streamed using ImarisWriter 1052 or Acquire 1054 onto the local NVME drive 1020 in the acquisition workstation 1000. Upon the completion of a tile, the NIC 1016 transfers the resulting files over a high-speed network (1021) onto the storage server 1040. This occurs in parallel with the acquisition of the next imaging tile. Upon completion of the transfer, the tile is deleted off the acquisition workstation's NVME drive 1020 to free space for subsequent tiles.

The raw data for each color channel includes a set of overlapping 3D image tiles. For the ImarisWriter acquisition workflow, the images are stored in Imaris IMS file format12, an HDF5-based format which enables fast parallel writing to local storage. However, this format is not well suited to being archived in cloud (object) storage 1042 since accessing an arbitrary data chunk involves seeking a file. Thus, the data is converted to OME Zarr format, which supports parallel read-write over the network and has a rich metadata structure. OME-Zarr is also integrated with visualization and annotation tools used for downstream visualization and analysis, including Horta Cloud and Neuroglancer.

With up to four channels, the storage footprint for a single dataset can reach hundreds of terabytes. The dataset can be compressed with one of a variety of lossless codecs. For example, Blosc ZStandard yields high storage ratios, with compression speeds comparable to LZ4 at lower ‘clevel’ settings (e.g., 1-3). Dask13 parallelizes the compression and OME-Zarr writing over a high-performance computing (HPC) cluster with 16 nodes, each with 32 Intel CPUs with Advanced Vector Instructions 2 (AVX2) and 256 GB RAM. Image chunks are read in parallel from high-bandwidth network storage, compressed in memory, and written directly to AWS S3 and Google Cloud Storage buckets. Combined throughput (chunk read, compress, write) can reach over 2 GB/s, with execution time dominated by read-write I/O operations. For the Acquire acquisition workflow, datasets are streamed directly to the OME-Zarr format.

### ExA-SPIM Image Stitching

ExA-SPIM image stitching can be performed with a combination of on-premises and cloud-based resources. Datasets can be converted from OME-Zarr to N5 and stitched using BigStitcher on the Google Cloud Platform (GCP). Tile placement transformations can be based on interest points. Interest point based tile registration includes three steps: (1) identifying the interest points, (2) finding corresponding interest points between tiles, and (3) optimizing for tile transformation parameters with respect to the distance of corresponding interest points. For the images included here, we first performed a translation-only stitching routine, followed by a full affine transformation optimization. The affine transformation was regularized by a rigid transformation and corner tiles were kept fixed to prevent the global scaling of the sample and divergent solutions at the corner tiles. As a rule of thumb, several thousand interest points per overlapping region were used for a reliable identification of correspondences and successful optimization.

Once the alignment transformations were calculated, the tiles were fused using the on-premises HPC into a single contiguous volume in the N5 format. A representative dataset (~100 TB in raw uncompressed size) can be fused in about 24 hours using 16 nodes (32 cores each, 480 total), with 16 GB of RAM per core (7.68 TB total) and an output chunk size of 256, 256, 256 pixels. Two cores per node are reserved as overhead per spark worker (i.e., 32 total for 16 nodes). Fused datasets along with the raw tiled datasets and the tile placement transformations are deposited in an AmazonWeb Services S3 aind-open-data data bucket. The N5 datasets were converted to OME-Zarr for visualization with Neuroglancer, or KTX14 for visualization with HortaCloud. This pipeline involves several file format conversion steps and transfers between on-premises and cloud-based platforms. Other suitable pipelines may be standardized around OME-Zarr and completely operable in the cloud, with initial data conversion and compression step computed on-premises.

### Whole-Brain Expansion

Tissue expansion for microscopy (ExM) enables imaging specimens at effective resolutions well below the diffraction limit of light microscopes. Moreover, ExM can produce optically clear specimens with low fluorescence background. Multiple ExM variations have emerged, driven by specific biological questions. These include engineered hydrogel chemistry for post-expansion molecular interrogation of proteins or RNA, formulations that provide gel stiffness, or tunable expansion up to >10×. Most of these protocols have been developed for specimens that are at most hundreds of micrometers thick.

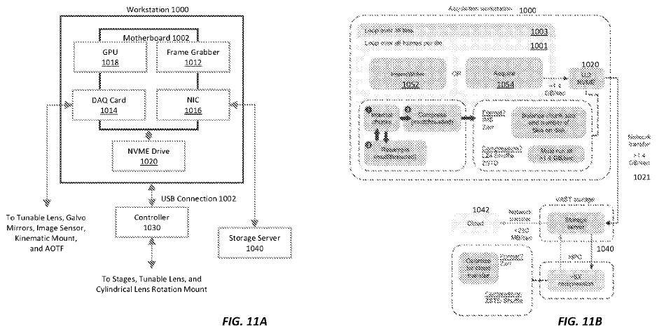

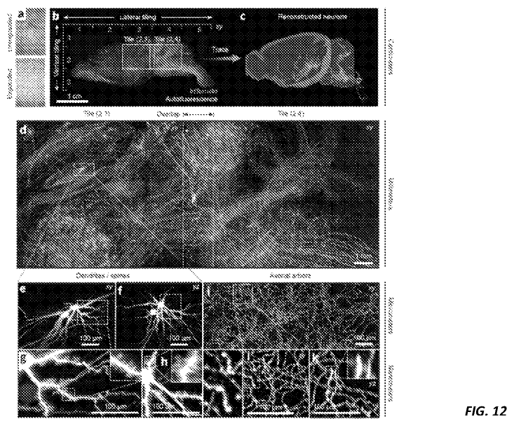

We developed ExM methods for centimeter-scale tissue samples, including entire mouse brains. Optical clearing for ExA-SPIM allows the entire volume to be imaged with diffraction-limited resolution without sectioning. Index of refraction inhomogeneities in heavily myelinated fiber tracts pose particular challenges. Clearing was achieved by stringent dehydration and delipidation prior to gelation and expansion. We systematically evaluated dehydration agents, including methanol, ethanol, and tetrahydrofuran (THF), followed by delipidation with commonly used protocols on 1 mm thick brain slices. Slices were expanded and examined for clarity under a macroscope. Dehydration using THE was followed by two sequential delipidation steps. First DISCO type clearing followed by aqueous delipidation rendered the samples extremely transparent (e.g., as shown in FIG. 12A, described below).

In addition to clearing specimens, delipidation facilitates immunolabeling brain samples prior to gelation and expansion. Signal amplification facilitates high contrast imaging of small structures, especially since the increase in volume upon expansion dilutes the concentration of the fluorophore. For gelation, we used VA-044 as the initiator instead of the more commonly used APS/TEMED. VA-044 initiates free radicals at a temperature-dependent rate. At low temperatures (e.g., 4 °C) the gelling reagents are allowed to diffuse to the center of thick samples, followed by higher temperatures (37 °C) to trigger uniform polymerization. Our protocol provides nearly isotropic expansion of the whole sample (including internal brain structures). Our protocol works for the mouse brain and for other large specimens, such as a 1×1×1.5 cm piece of macaque motor cortex or a 1×1×0.01 cm section of human visual cortex.

Imaging Single Neurons across Entire Mouse Brains

FIGS. 12A-12K illustrate images of mouse brains obtained with the ExA-SPIM system described above. FIGS. 12A-12C show a cleared and expanded entire mouse brain, individual neurons, and reconstructed axonal projections of the neurons, respectively. Tracking the axons of individual neurons is a challenging problem—axons collaterals can be very thin (e.g., <100 nm) and traverse large distances (e.g., centimeters), spanning vast areas of the brain. This involves high-resolution, high-contrast imaging of the entire brain without loss of data. Current best-in-class approaches involves physical sectioning and extensive tiling, which complicates downstream data processing. In addition, imaging spans multiple days, which increases the chance for experimental failure and data loss. Finally, the resolution of these imaging methods is highly anisotropic (typically <1:6), which compromises the ability to perform unambiguous axon tracing. ExA-SPIM enables imaging an entire mouse brain in 24 hours, without cutting, using only 15 tiles at near-isotropic resolution.

To generate the images in FIGS. 12A-12K, we expressed tdTomato in a sparse subset of vglut²⁺ neurons in a Slc17a6-Cre mouse to label subcortical projection neurons. Brains were expanded (3×) and imaged in 15 tiles (e.g., as in FIG. 10A). Because of the lack of physical tissue slicing, minimal tiling, and excellent performance of the ExA-SPIM system, individual tile volumes are nearly perfectly registered based on stage coordinates alone, as evident by the close alignment of axons across tile boundaries shown in FIG. 3D. Individual dendritic spines and axonal varicosities are clearly visible in FIGS. 3E-3H, and long-range axons can be tracked across the brain in FIGS. 3I-3K. FIG. 3C shows representative tracings from an ExA-SPIM imaged brain.

To generate the whole-brain single neuron reconstruction shown in FIG. 12C, we used HortaCloud, an open-source streaming 3D annotation platform enabling fast visualization and collaborative proofreading of terabyte-scale image volumes. A human annotator proofread stitched image volumes using HortaCloud in a web browser on a personal workstation. Starting from the soma, the axonal and dendritic arbors were traced through all terminals by laying down connected points along the neurite, producing a piecewise-linear approximation of neuronal trees.

### Imaging Cortico-Spinal Tract Neuron in Macaque Motor Cortex

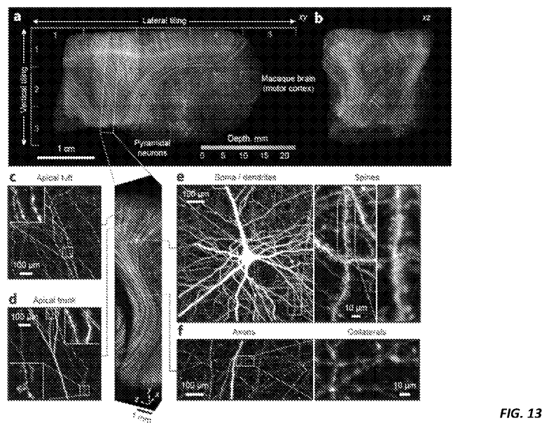

FIGS. 13A-13F show ExA-SPIM applied to a larger brain. With minor adaptations, we applied our clearing and expansion protocol to a 1×1×1.5 cm block of pigtail macaque brain from the hand-wrist and trunk regions of primary motor cortex. This neocortical region of the primate brain is particularly difficult to clear and image due to its highly myelinated content. The specimen contained cortico-spinal neurons expressing a fluorescent protein (tdTomato) driven by retrograde AAV injected into the intermediate and ventral laminae. FIGS. 13A and 13B show ExA-SPIM image volumes that reveal brightly labeled cortico-spinal neurons. Individual neurons, their dendritic arbors, and extensive dendritic spines as well as the descending axon and collaterals are clearly discernible in FIGS. 13C-13F.

Additionally, even in down-sampled data (e.g., roughly 1 μm effective voxel size), we can follow axonal pathways. This means that with a small number of slices (e.g., 6×1 cm thick slabs) and reduced imaging resolution (e.g., about 1×1×2.5 μm), the modified inverted or open-top ExA-SPIM design shown in FIG. 8B could provide a mesoscale map of white matter axons across the entire macaque brain. Open-top ExA-SPIM could image a single brain in about four days. Existing efforts to map pathways in the primate brain at this resolution involve slicing the brain in 300 μm sections and laboriously assembling the resulting images into a coherent 3D volume.

### Tracing Axons in Human Neocortex and White Matter

Heavy chain neurofilaments comprise the internal scaffolds of long-range projection axons. Visualizing these neurofilaments with immunofluorescence could provide detailed information about axonal trajectories without the need for gene transfer methods, and which cannot be achieved with other methods, such as diffusion magnetic resonance imaging or high-resolution optical coherence tomography.

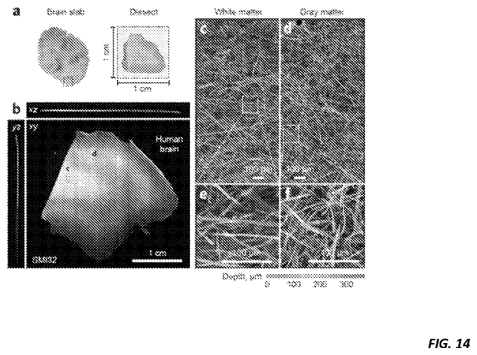

FIGS. 14A-14F show ExA-SPIM images of immunolabeled heavy chain neurofilaments in the human neocortex. FIG. 14A shows a roughly 1×1×0.01 cm piece of human neocortex that was cleared, expanded (4×), and labeled the tissue with fluorescent SMI-32, which preferentially stains heavy chain neurofilaments. FIG. 14B shows individual axons and their trajectories through a 350 μm thick sample with near-isotropic resolution, as seen in FIGS. 14C-14F. The larger axons (>1 μm) are well separated from each other in both the gray and white matter, allowing robust automated and manual tracing. In the white matter, axons are arranged as multiple intercalated populations coursing in different directions, rather than as homogeneous fascicles. These results demonstrate the feasibility of using ExA-SPIM for tracing white matter tract axons and lay the foundation for scaling this data acquisition to multiple, thick tissue sections, and ultimately the entire human brain.

### Viral Labeling in Mice

The images in FIGS. 12A-12K are from adult transgenic Cre driver mice between ages p21 to p35. These mice received systemic injections, via the retro-orbital sinus, of a 100 μL mixture of Cre-dependent Tet transactivator (AAV-PHP-eB_Syn-FlexTRE-2tTA, typical dose 6.0×10⁸ gc/mL) and a reporter virus (AAV-PHP-eB_7x-TRE-tdTomato, typical dose 1.8×10¹¹ gc/mL). The viral titers of the tTA virus used were empirically adjusted based on the Cre driver line to yield sparsely labeled brains. Viruses were obtained from either the Allen Institute for Brain 485 Sciences viral vector core, the University of North Carolina, or BICCN-Neurotools core and were prepared in an AAV buffer made of 1×PBS, 5% sorbitol, and 350 mM NaCl.

### Mice Brain Tissue Collection

All experimental procedures related to the use of mice were approved by the Institutional Animal Care and Use Committee of the Allen Institute for Brain Science, in accordance with National Institutes of Health (NIH) guidelines. Four weeks after viral transfection, mice (~p70) were anesthetized with an overdose of isoflurane and then transcardially perfused with 10 mL 0.9% saline at a flow rate of 9 mL/min followed by 50 mL 4% paraformaldehyde in PBS at a flow rate of 9 mL/min. Brains were extracted and post-fixed in 4% paraformaldehyde at room temperature for 3-6 hours and then left at 4 °C overnight (12-14 hours). The following day, brains were washed in 1×PBS to remove all traces of excess

### Macaque Brain Tissue Collection

The macaque brain samples shown in FIGS. 13A-13F were collected as follows. To retrogradely label corticospinal neurons in the hand-wrist and trunk regions of primary motor cortex in a pigtail macaque, we injected a retro AAV vector (rAAV2-CAG-tdTomato) into the left lateral funiculus and ventrolateral part of the gray matter in the C6/C7 spinal segments. All animal procedures were approved by the University of Washington IACUC committee and conformed to the NIH's Guide for the Care and Use of Laboratory Animals.

An 11 year and 4 months old female Macaca nemestrina (10.55 kg) designated for the tissue distribution program was anaesthetized with isoflurane after an initial sedation with ketamine. The monkey was paralyzed with a neuromuscular blocker and artificially ventilated. The animal was monitored by a trained surgical technician for pulse oximetry, body temperature, ECG, blood pressure, capnography, and inspired oxygen. External thermal support was provided for the duration of the surgery, and an intravenous line for intravenous drug and isotonic fluid administration, a urethral catheter was inserted to maintain fluid volume and physiological homeostasis. Under aseptic conditions, a partial laminectomy of the C5-C7 vertebrae was performed to expose the left dorsal surface of the cervical enlargement.

Using a stereotaxic manipulator (Kopf Instruments, Tujunga, CA) on a custom frame, targeted microinjections were performed with a Nanoject II (Drummond Scientific, Broomall, PA). A glass pipette with a broken tip filled with rAAV2-CAG-tdTomato was inserted into the spinal cord through small longitudinal incision of the dura. Using the dorsal root entry points as a guide, seven injection tracts spanning dorsal-ventral were used to target the lateral funiculus and ventrolateral part of the gray matter in the C6/C7 spinal segments. Each tract had five injections (138 nL of virus at 23 nL/second) positioned 100 μm apart spanning −4.1 mm to −3.7 mm from the surface of the cord. The seven tract locations spanned 2.2 mm anterior-posterior and were in two rows (1 mm apart), evenly spread with slight adjustments to avoid hitting the vasculature. A one-minute wait period was used prior to each first injection within the tract, a two-minute wait period after each injection before moving the pipette and a five-minute wait period before removing the electrode after the final injection for each tract. The injector's efficacy at ejecting virus was confirmed between each injection tract.

After the injections were complete, artificial dura was placed over the durotomy, the musculature and skin were sutured, and an anti-paralytic agent (atropine) was delivered. Post-operative monitoring and care were performed to minimize pain and distress. Thirty days after the original injections, the animal was anaesthetized as described above, and then euthanized using a lethal dose of pentobarbital solution. After death, the animal was perfused transcardially with sodium-free oxygenated ice-cold artificial cerebrospinal fluid (NMDG-aCSF in mM): 92 NMDG, 25 glucose, 30 NaHCO3, 20 HEPES, 10 MgSO4, 2.5 KCl, 1.2 NaH2PO4, 0.5 CaCl2, 3 sodium pyruvate, 2 thiourea, 5 sodium ascorbate. After perfusion, the brain was removed and the right hemisphere trunk and hand wrist subregions of primary motor cortex were dissected and stored in NMDG-saline on ice. A portion (2 cm³) of the motor cortex was further sub-dissected and stored in freshly made 4% paraformaldehyde in 0.1 M phosphate-buffered saline for later processing.

### Mouse and Macaque Brain Delipidation, Immunolabeling, Gelation and Expansion

Whole mouse and macaque brain delipidation was performed in two stages. First, brains were dehydrated through a gradient of tetrahydrofuran (THF) in deionized water at 4 °C and then delipidated in anhydrous dichloromethane (DCM) at 4 °C. The brains were rehydrated into water through a gradient of THF and then placed in 1×PBS. Second, whole brains were transferred from 1×PBS to a biphasic buffer (SBiP) for five days at room temperature and then rinsed in a detergent buffer (Bln) for two days.

Delipidated brains were equilibrated in a detergent buffer (PTxw) and then incubated in PTxw containing the primary antibody (10 μg/brain) at room temperature for eleven days. After thorough washing in PTxw, a solution of the secondary antibody (20 μg/brain) was added for eleven days at room temperature. Brains were then rinsed thoroughly with PTxw and transferred to 1×PBS.

Immunolabeled brains were equilibrated in MES buffered saline (MBS) followed by incubation in acryloyl-X SE (AcX) at 4 °C on wet ice for four days. The AcX solution was then rinsed off with 1×PBS and the brain was then transferred to a solution of StockX activated with VA-044 at 4 °C on wet ice for four days. After StockX incubation, whole brains were placed in a polymerization chamber and filled with activated StockX solution. The chamber was sealed with a coverslip, placed in an inert atmosphere of nitrogen, and baked at 37 °C for 4+ hours until hydrogel formation. The hydrogel was then digested with proteinase K for 10+ days until the tissue cleared. Upon completion of digestion, the brain was rinsed with 1×PBS and expanded in 0.05× saline sodium citrate (SSC) until 3× expansion was achieved.

### Human Brain Tissue Collection, Delipidation, Labeling, Gelation, and Expansion

Deidentified postmortem adult human brain tissue (61-year-old male, Hispanic, no known history of neuropsychiatric or neurological conditions) was obtained with permission from next-of-kin by the San Diego Medical Examiner's Office. Tissue procurement was reviewed by the Western Institutional Review Board (WIRB) and did not constitute human subject research requiring Institutional Review Board (IRB) review, in accordance with federal regulation 45 C.F.R. § 46 and associated guidance. Postmortem tissue collection was performed in accordance with the Uniform Anatomical Gift Act described in Health and Safety Code §§ 7150 et seq, and other applicable state and federal laws and regulations.

Tissue was manually sliced into 1 cm coronal slabs, flash frozen with liquid nitrogen, vacuum sealed, and stored at −80 °C by the Allen Institute Tissue Processing Team. One slab from the occipital pole was drop-fixed in 4% PFA for approximately 12 hours at 4 °C, and tissue regions containing visual cortex were dissected into ~1 cm blocks for histological processing. Individual blocks were then SHIELD-fixed prior to sectioning at 100 μm on a sliding freezing microtome to further protect protein antigenicity and tissue architecture.

Individual free-floating sections were then passively delipidated (LifeCanvas Technologies) for one week prior to immunolabeling. Delipidated sections were subsequently immunolabeled for SMI-32, which identifies heavy chain neurofilaments that make up axon scaffolds in long-range projection neurons. Free-floating sections were blocked in NGSTU (5% goat serum, 570 0.6% Triton X-100, 4M urea in 1×PBS) overnight, incubated with a primary antibody (rabbit anti-neurofilament 200, Sigma Aldrich N4142) diluted 1:500 in NGSTU+0.02% sodium azide for five days, followed by a secondary antibody incubation (goat anti-rabbit AF488, ThermoFisher A-11034) diluted 1:100 in NGST (5% goat serum, 0.6% Triton X-100 in 1×PBS) for four days. Due to the thinness (100 μm) of this tissue compared to an entire mouse brain, the gelling protocol used varied slightly from the whole brain gelling protocol described above. Most notably, the thermal initiator used was ammonium persulfate (APS) instead of VA-044, the tissue was polymerized at room temperature for three days, and the resulting tissue-hydrogel matrix was digested using a 1:50 concentration of proteinase-k in buffer (5% Sodium Dodecyl Sulfate, 5% Triton X-100, 10% 1M TRIS pH8).

The expanded samples were trimmed to produce smooth edges and then placed in an anodized imaging chamber. The sample chamber assembly was performed in a large bath of the expansion and imaging solution (0.05×SSC). The smooth edges of the hydrogel were placed against the chamber panels corresponding to the excitation and emission path and then the chamber removed from the bath. A warm (55 °C) solution of 2% agarose, in the same 0.05×SSC as used during expansion, was carefully poured into the chamber space behind the hydrogel for structural rigidity during imaging and let cool to room temperature until solid. The chamber was then sealed and placed in 0.05×SSC for equilibration overnight before imaging.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A light sheet imaging system for imaging a biological sample, comprising:
a first objective lens, in optical communication with the biological sample, to illuminate a selected location within the biological sample with a light sheet;
a second objective lens, in optical communication with the biological sample, to collect fluorescence emitted by the biological sample in response to the light sheet, the second objective lens having an étendue of at least 8 mm², a numerical aperture of at least 0.10, a Strehl ratio >0.8 when imaging through optical glass with a predetermined thickness greater than 10 mm, and a Strehl ratio <0.8 when imaging purely in air;
an immersion chamber, in optical communication with the first objective lens and with the second objective lens, to hold the biological sample in a liquid medium having a refractive index within 0.1 of the refractive index of the biological sample across a spectrum of the fluorescence; and
a detector, in optical communication with the second objective lens, to detect the fluorescence collected by the second objective lens.

2. The light sheet imaging system of claim 1, wherein the biological sample is an optically cleared and/or expanded tissue.

3. The light sheet imaging system of claim 1, wherein the second objective lens is a finite conjugate lens.

4. The light sheet imaging system of claim 1, wherein the second objective lens is configured to detect the fluorescence through a window in the immersion chamber.

5. The light sheet imaging system of claim 4, wherein the second objective lens is aligned perpendicular to the window to reduce optical aberrations.

6. The light sheet imaging system of claim 1, wherein the predetermined thickness of optical glass is one of 25 mm or 35 mm.

7. The light sheet imaging system of claim 1, wherein the liquid medium has a refractive index from about 1.2 to about 1.7.

8. The light sheet imaging system of claim 1, wherein the liquid medium has a refractive index within about 0.1 of a refractive index of the biological sample.

9. The light sheet imaging system of claim 1, wherein the detector comprises over 100 Megapixels.

10. The light sheet imaging system of claim 1, further comprising:
a filter, in optical communication with the biological sample, the second objective lens, and the detector, to prevent light at a wavelength of the light sheet from illuminating the detector.

11. The light sheet imaging system of claim 1, further comprising:
a kinematic mount, mechanically coupled to the second objective lens, to align the second objective lens with respect to the biological sample.

12. The light sheet imaging system of claim 1, further comprising:
a processor, operably coupled to the detector, to generate a fluorescence image based on the fluorescence.

13. A method of imaging a biological sample immersed in a liquid medium, the method comprising:
illuminating the biological sample with a light sheet via a first objective lens;
collecting, via a second objective lens through the liquid medium and through air, fluorescence generated by the biological sample in response to the light sheet, the second objective lens having an étendue of at least 8 mm², a numerical aperture of at least 0.10, a Strehl ratio >0.8 when imaging through optical glass with a predetermined thickness greater than 10 mm, and a Strehl ratio <0.8 when imaging purely in air;
detecting, by a sensor, the fluorescence collected by the second objective lens; and
generating an image of the biological sample based on the fluorescence.

14. The method of claim 13, wherein the biological sample comprises mammalian brain tissue.

15. The method of claim 13, wherein the biological sample comprises human brain tissue.

16. The method of claim 13, wherein the liquid medium has a refractive index within about 0.1 of a refractive index of the biological sample.

17. The method of claim 13, wherein the liquid medium has a refractive index from about 1.2 to about 1.7.

18. A light sheet imaging system for imaging a biological sample, comprising:
an immersion chamber to hold the biological sample within a liquid having a refractive index within 0.1 of the biological sample at a fluorescence wavelength;
an excitation source, in optical communication with the immersion chamber, to illuminate a selected location within the biological sample with a light sheet;
a finite conjugate lens, in optical communication with the immersion chamber and spaced apart from the biological sample by at least 10 mm of the liquid and at least 1 mm of air, to form a diffraction-limited image of fluorescence emitted by the biological sample at the fluorescence wavelength in response to the light sheet; and
a detector, in a back focal plane of the finite conjugate lens, to detects the diffraction-limited image.

19. The light sheet imaging system of claim 18, wherein the finite conjugate lens has a numerical aperture greater than 0.1.

20. The light sheet imaging system of claim 18, wherein the finite conjugate lens has a working distance of up to 35 mm.
